(19) United States
(12) Patent Application Publication
(10) Pub. No.: US 2026/0050537 A1
(43) Pub. Date: Feb. 19, 2026

(54) TECHNIQUES FOR GENERATING CODE WITH INTEGRATED ABSTRACT SYNTAX TREE-BASED WAVEFORM TRACING

(71) Applicant: NVIDIA CORPORATION, Santa Clara, CA (US)

(72) Inventors: Chia-Tung HO, Santa Clara, CA (US); Hoaxing REN, Austin, TX (US)

(21) Appl. No.: 19/199,079

(22) Filed: May 5, 2025

Related U.S. Application Data
(60) Provisional application No. 63/682,638, filed on Aug. 13, 2024.

(51) Int. Cl. G06F 11/362; G06F 11/3698

(52) U.S. Cl. CPC G06F 11/3636; G06F 11/3698

(57) ABSTRACT

A computer-implemented technique for generating program code includes receiving a natural language description of a hardware module, generating a first plan based on the natural language description, extracting first circuit information from the natural language description, generating a second plan based on the first plan and the first circuit information, and generating first program code in a hardware description language based on the second plan.

### CROSS-REFERENCE TO RELATED APPLICATIONS

This application claims priority benefit of the United States Provisional Patent Application titled, “Autonomous Plan-Driven Verilog Code Generation with Integrated Abstract Syntax Tree-based Waveform Tracing Tool,” filed on Aug. 13, 2024, and having Ser. No. 63/682,638. The subject matter of this related application is hereby incorporated herein by reference.

### BACKGROUND

### Field of the Various Embodiments

The various embodiments relate generally to computer science, artificial intelligence (AI), and machine learning and, more specifically, to techniques for generating code with integrated abstract syntax tree-based waveform tracing.

### Description of the Related Art

In machine learning, language models are one type of machine learning model that generates text. Language models have become increasingly capable of performing various natural language processing tasks. Large language models (LLMs) are one type of language model. Conventionally, an LLM is implemented as a neural network that includes a large number (e.g., billions) of parameters and is trained on a large quantity of text data.

Once trained, an LLM is oftentimes able to perform a wide variety of natural language processing tasks. One natural language processing task that a trained LLM can perform is code generation. Code generation is the process of automatically generating program code given an input, such as natural language text. For example, an LLM can be prompted, using a natural language description of a hardware module, to generate program code for the hardware module in a hardware description language. Hardware description languages are specialized programming languages, such as Verilog, that are used to describe the structure and behavior of electronic circuits. Program code in a hardware description language can be used to model circuits, simulate functionality of those circuits, and verify correctness before physical manufacturing of those circuits.

One drawback of conventional language models, and conventional LLMs in particular, is that these models sometimes generate incorrect program code that cannot be successfully executed and/or that do not perform the functionalities specified in the natural language text that is input into the LLMs. Conventional LLMs perform especially poorly when generating program code for hardware modules in hardware description languages. Unlike other types of program code that typically execute one line after another in a sequential manner, program code in hardware description languages oftentimes include sequentially executing code as well as asynchronously executing code. The sequentially executing code and the asynchronously executing code can also execute in different clock cycles before being synchronized. Even when an LLM is specifically trained to generate program code in a hardware description language, the trained LLM can generate program code that does not correctly implement all of the details in the natural language descriptions of the hardware modules, such as all of the state transition logic.

As the foregoing illustrates, what is needed in the art are more effective techniques for generating program code in hardware description languages.

### SUMMARY

One embodiment of the present disclosure sets forth a computer-implemented method for generating program code. The method includes receiving a natural language description of a hardware module. The method further includes generating a first plan based on the natural language description. The method also includes extracting first circuit information from the natural language description, and generating a second plan based on the first plan and the first circuit information. In addition, the method includes generating first program code in a hardware description language based on the second plan.

Another embodiment of the present disclosure sets forth a computer-implemented method for debugging program code. The method includes receiving first program code in a hardware description language. The method further includes simulating a hardware module based on the first program code to generate one or more simulation results that include one or more functional errors in the first program code.

The method also includes generating a tree data structure based on the one or more simulation results, and tracing one or more waveforms based on the tree data structure and the one or more functional errors to determine one or more first signals. In addition, the method includes generating second program code in the hardware description language based on the first program code and the one or more first signals.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is the disclosed techniques automatically generate program code in hardware description languages while implementing all of the details, such as state transition logic and other low-level circuit information, that are specified by natural language descriptions of hardware modules. In addition, the disclosed techniques automatically correct syntax and functional errors in the generated program code. Accordingly, more correct program code in hardware description languages can be generated relative to what could be generated using conventional approaches, allowing hardware to be developed faster and with fewer defects as well as improved functional correctness in the program code from which the hardware can be designed. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the present embodiments;

FIG. 2 is a block diagram of a parallel processing unit (PPU) included in the parallel processing subsystem of FIG. 1, according to various embodiments;

FIG. 3 is a block diagram of a general processing cluster (GPC) included in the PPU of FIG. 2, according to various embodiments;

FIG. 4 is a more detailed illustration of the code generator of FIG. 1, according to various embodiments;

FIG. 5 is a more detailed illustration of the high-level planner agent of FIG. 4, according to various embodiments;

FIG. 6 illustrates an exemplar prompt for the high-level planner agent of FIG. 4, according to various embodiments;

FIG. 7 illustrates an exemplar prompt for the circuit signal, transition, example extraction agent of FIG. 4, according to various embodiments;

FIG. 8 is a more detailed illustration of the graph retrieval agent of FIG. 4, according to various embodiments;

FIG. 9 illustrates an exemplar prompt for the graph retrieval agent of FIG. 4, according to various embodiments;

FIG. 10 illustrates exemplar reasoning of an engineer agent and interactions with the retrieval tool of FIG. 8, according to various embodiments;

FIG. 11 is a more detailed illustration of the coding agent of FIG. 4, according to various embodiments;

FIG. 12 illustrates an exemplar prompt for the coding agent of FIG. 4, according to various embodiments;

FIG. 13 is a more detailed illustration of the debugging agent of FIG. 4, according to various embodiments;

FIG. 14 illustrates an exemplar prompt for the debugging agent of FIG. 4, according to various embodiments;

FIG. 15 illustrates exemplar reasoning of an engineer agent and interactions with an AST-based waveform tracing tool and a simulator tool to debug program code, according to various embodiments.

FIG. 16 is a flow diagram of method steps for generating program code in a hardware description language, according to various embodiments; and

FIG. 17 is a flow diagram of method steps for debugging program code in a hardware description language, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### General Overview

Embodiments of the present disclosure provide techniques for generating program code in a hardware description language, such as Verilog. In some embodiments, a high-level planner agent receives a natural language description of a hardware module and generates a high-level plan that includes a set of sub-tasks for programming the hardware module described by the natural language description. A circuit signal, transition, and example extraction agent extracts low-level circuit information, such as circuit signals, state transitions, and signal examples, from the natural language description and outputs the extracted information in a structured format. The sub-tasks in the high-level plan generated by the high-level planner agent and the low-level circuit information extracted by the circuit signal, transition, and example extraction agent are represented as nodes in a task-driven circuit relation graph that includes the nodes and edges between related nodes. A task-driven circuit relation graph retrieval agent retrieves, from the task-driven circuit relation graph, low-level circuit information that is relevant to each sub-task. The task-driven circuit relation graph retrieval agent augments the high-level plan with the retrieved low-level circuit information to generate a task plan in the form of a graph. A coding agent processes each sub-task in the task plan graph in a step-by-step manner to generate program code for the sub-task in the hardware description language, and the coding agent corrects syntax errors in the generated code until program code without syntax errors is generated. Then, a debugging agent verifies the syntax and functionality of the generated program code for the entire hardware module, and the debugging agent corrects syntax and functional errors in the generated code.

In some embodiments, the debugging agent uses a simulator tool to check the syntax and functionality of the generated code. Simulation results output by the simulator tool are used to create an abstract syntax tree (AST). When functional errors are identified, the debugging agent inputs a mismatched output signal that is identified by the simulator tool and a desired back-tracing level into a waveform tracing tool that starts from the mismatched signal and iteratively extracts RVALUE (right-hand side value) signals until the specified back-tracing level is reached in the AST. The waveform tracing tool outputs the program code for reference, a tabular waveform of the mismatched signal, and the extracted RVALUE signals. The debugging agent uses the output of the waveform tracing tool to perform reasoning through a thought-action-observation process to generate new program code in the hardware description language, until program code without functional errors is generated.

The techniques for generating program code in hardware description languages have many real-world applications. For example, these techniques can be used to generate program code for a hardware module. Using the generated program code, the hardware module can then be simulated, verified for correctness, and/or manufactured.

The above examples are not in any way intended to be limiting. As persons skilled in the art will appreciate, as a general matter, the techniques for generating program code in hardware description languages that are described herein can be implemented in any application where generating program code in a hardware description language is required or useful.

### System Overview

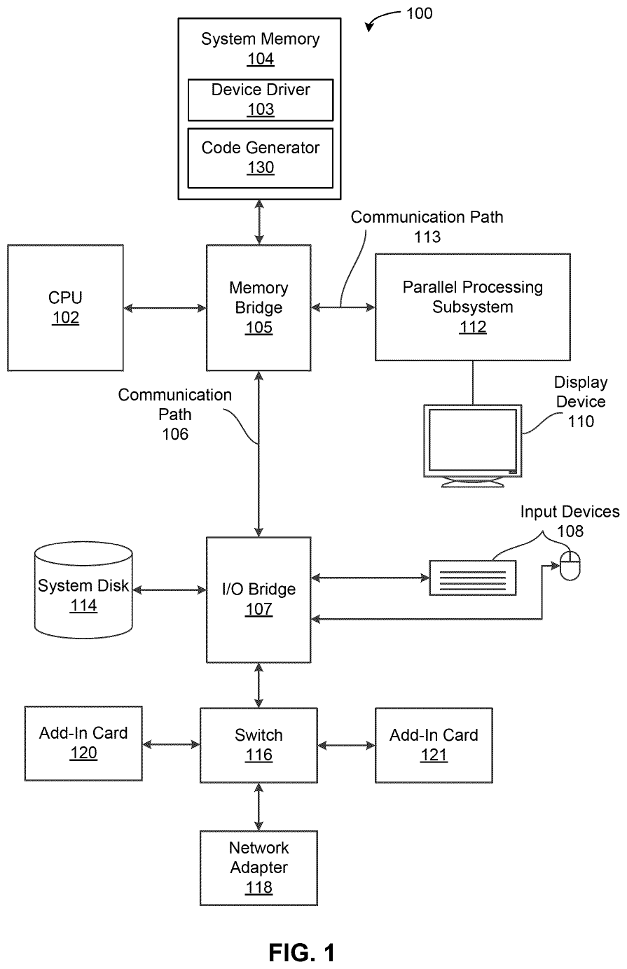

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, the computer system 100 is a server machine operating in a data center or a cloud computing environment that provides scalable computing resources as a service over a network.

In various embodiments, the computer system 100 includes, without limitation, a central processing unit (CPU) 102 and a system memory 104 coupled to a parallel processing subsystem 112 via a memory bridge 105 and a communication path 113. The memory bridge 105 is further coupled to an I/O (input/output) bridge 107 via a communication path 106, and the I/O bridge 107 is, in turn, coupled to a switch 116.

In one embodiment, the I/O bridge 107 is configured to receive user input information from optional input devices 108, such as a keyboard or a mouse, and forward the input information to CPU 102 for processing via the communication path 106 and the memory bridge 105. In some embodiments, the computer system 100 may be a server machine in a cloud computing environment. In such embodiments, the computer system 100 may not have the input devices 108. Instead, the computer system 100 may receive equivalent input information by receiving commands in the form of messages transmitted over a network and received via the network adapter 118. In one embodiment, the switch 116 is configured to provide connections between the I/O bridge 107 and other components of the computer system 100, such as a network adapter 118 and various add-in cards 120 and 121.

In one embodiment, the I/O bridge 107 is coupled to a system disk 114 that may be configured to store content and applications and data for use by the CPU 102 and the parallel processing subsystem 112. In one embodiment, the system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 107 as well.

In various embodiments, the memory bridge 105 may be a Northbridge chip, and the I/O bridge 107 may be a Southbridge chip. In addition, the communication paths 106 and 113, as well as other communication paths within the computer system 100, may be implemented using any technically suitable protocols, including, without limitation, AGP (Accelerated Graphics Port), HyperTransport, or any other bus or point-to-point communication protocol known in the art.

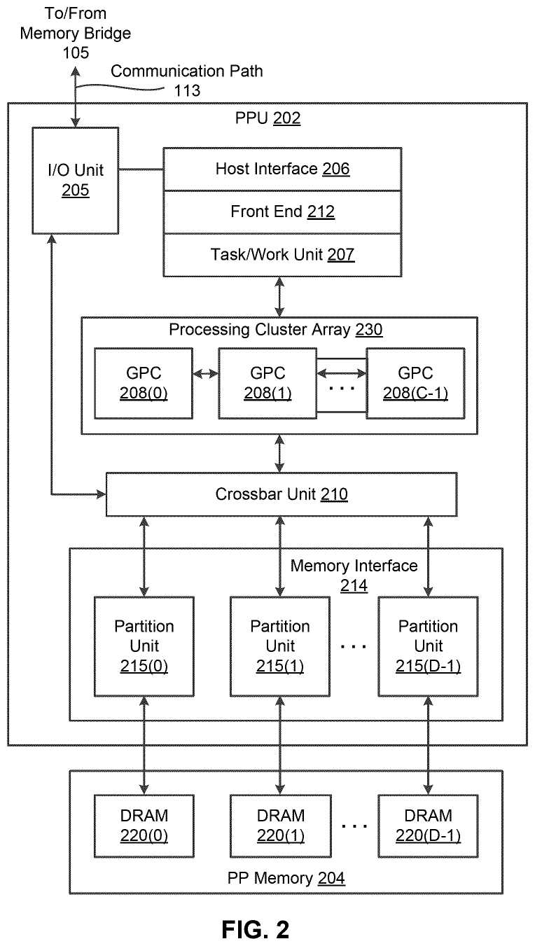

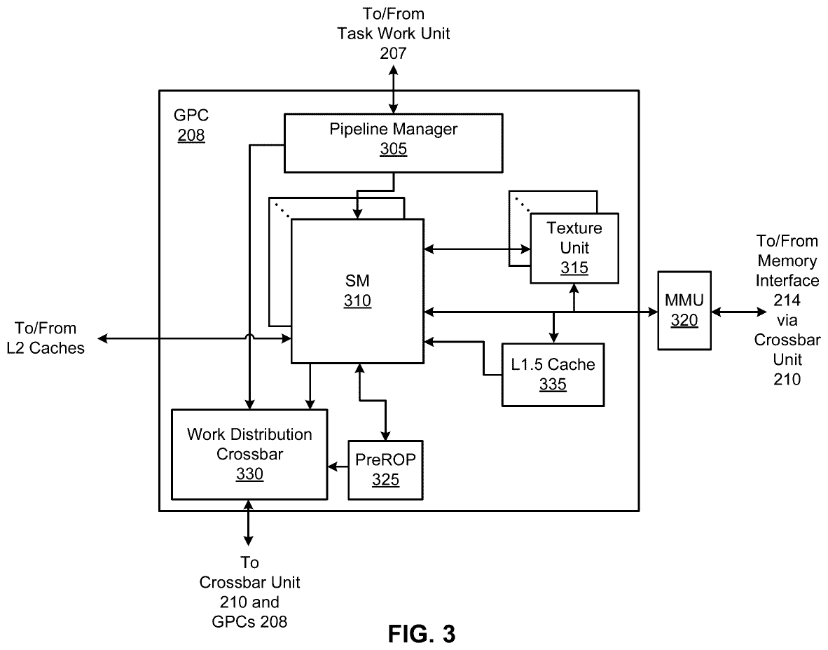

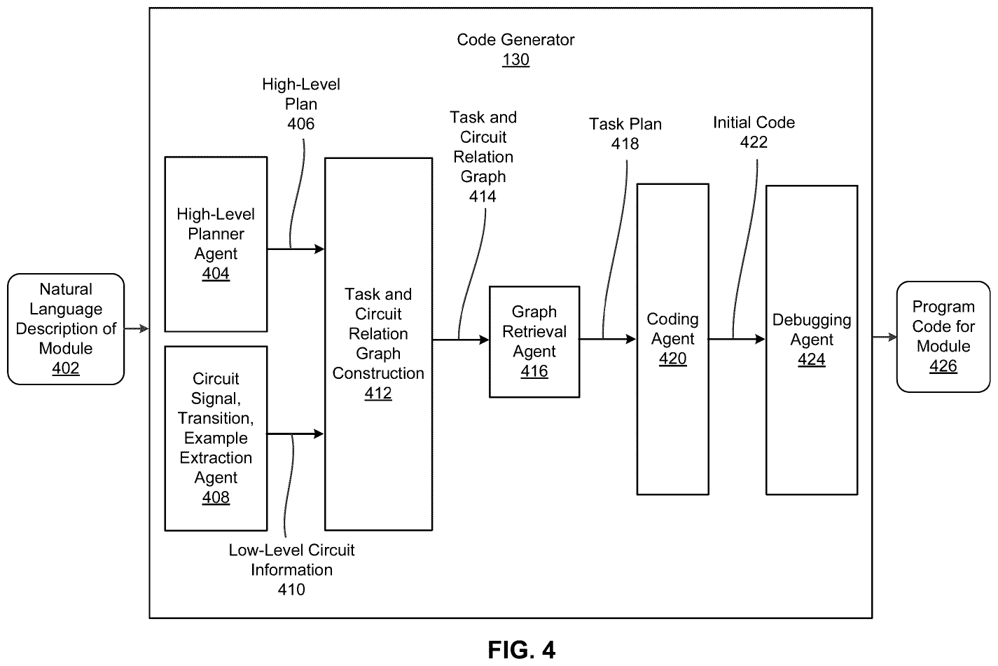

In some embodiments, the parallel processing subsystem 112 comprises a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within the parallel processing subsystem 112. In other embodiments, the parallel processing subsystem 112 incorporates circuitry optimized for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and compute processing operations. The system memory 104 includes at least one device driver 103 configured to manage the processing operations of the one or more PPUs within parallel processing subsystem 112. In addition, the system memory 104 includes a code generator 130. The code generator 130 is an application that uses artificial intelligence agents to generate and debug program code in a hardware description language, as described below in conjunction with FIGS. 4-17. Although described herein primarily with respect to the code generator 130, techniques disclosed herein can also be implemented, either entirely or in part, in other software and/or hardware, such as in the parallel processing subsystem 112.

In various embodiments, the parallel processing subsystem 112 may be integrated with one or more of the other elements of FIG. 1 to form a single system. For example, the parallel processing subsystem 112 may be integrated with the CPU 102 and other connection circuitry on a single chip to form a system on chip (SoC).

In some embodiments, the CPU 102 is the master processor of the computer system 100, controlling and coordinating operations of other system components. In one embodiment, the CPU 102 issues commands that control the operation of PPUs. In some embodiments, the communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, the system memory 104 could be connected to the CPU 102 directly rather than through the memory bridge 105, and other devices would communicate with the system memory 104 via the memory bridge 105 and the CPU 102. In other embodiments, the parallel processing subsystem 112 may be connected to the I/O bridge 107 or directly to the CPU 102, rather than to the memory bridge 105. In still other embodiments, the I/O bridge 107 and the memory bridge 105 may be integrated into a single chip instead of existing as one or more discrete devices. In certain embodiments, one or more components shown in FIG. 1 may not be present. For example, the switch 116 could be eliminated, and the network adapter 118 and the add-in cards 120, 121 would connect directly to the I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in some embodiments. For example, the parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in the parallel processing subsystem 112 of FIG. 1, according to various embodiments. Although FIG. 2 depicts one PPU 202, as indicated above, parallel processing subsystem 112 may include any number of PPUs 202. As shown, the PPU 202 is coupled to a local parallel processing (PP) memory 204. The PPU 202 and PP memory 204 may be implemented using one or more integrated circuit devices, such as programmable processors, application specific integrated circuits (ASICs), or memory devices, or in any other technically feasible fashion.

In some embodiments, the PPU 202 comprises a GPU that may be configured to implement a graphics rendering pipeline to perform various operations related to generating pixel data based on graphics data supplied by the CPU 102 and/or system memory 104. When processing graphics data, the PP memory 204 can be used as graphics memory that stores one or more conventional frame buffers and, if needed, one or more other render targets as well. Among other things, the PP memory 204 may be used to store and update pixel data and deliver final pixel data or display frames to an optional display device 110 for display. In some embodiments, the PPU 202 also may be configured for general-purpose processing and compute operations. In some embodiments, the computer system 100 may be a server machine in a cloud computing environment. In such embodiments, the computer system 100 may not have a display device 110. Instead, the computer system 100 may generate equivalent output information by transmitting commands in the form of messages over a network via the network adapter 118.

In some embodiments, the CPU 102 is the master processor of computer system 100, controlling and coordinating operations of other system components. In one embodiment, the CPU 102 issues commands that control the operation of the PPU 202. In some embodiments, the CPU 102 writes a stream of commands for the PPU 202 to a data structure (not explicitly shown in either FIG. 1 or FIG. 2) that may be located in the system memory 104, the PP memory 204, or another storage location accessible to both the CPU 102 and the PPU 202. A pointer to the data structure is written to a command queue, also referred to herein as a pushbuffer, to initiate processing of the stream of commands in the data structure. In one embodiment, the PPU 202 reads command streams from the command queue and then executes commands asynchronously relative to the operation of the CPU 102. In embodiments where multiple pushbuffers are generated, execution priorities may be specified for each pushbuffer by an application program via device driver to control scheduling of the different pushbuffers.

In one embodiment, the PPU 202 includes an I/O (input/output) unit 205 that communicates with the rest of the computer system 100 via the communication path 113 and the memory bridge 105. In one embodiment, I/O unit 205 generates packets (or other signals) for transmission on the communication path 113 and also receives all incoming packets (or other signals) from the communication path 113, directing the incoming packets to appropriate components of the PPU 202. For example, commands related to processing tasks may be directed to a host interface 206, while commands related to memory operations (e.g., reading from or writing to PP memory 204) may be directed to a crossbar unit 210. In one embodiment, the host interface 206 reads each command queue and transmits the command stream stored in the command queue to a front end 212.

As mentioned above in conjunction with FIG. 1, the connection of the PPU 202 to the rest of the computer system 100 may be varied. In some embodiments, the parallel processing subsystem 112, which includes at least one PPU 202, is implemented as an add-in card that can be inserted into an expansion slot of the computer system 100. In other embodiments, the PPU 202 can be integrated on a single chip with a bus bridge, such as the memory bridge 105 or the I/O bridge 107. Again, in still other embodiments, some or all of the elements of the PPU 202 may be included along with the CPU 102 in a single integrated circuit or system of chip (SoC).

In one embodiment, the front end 212 transmits processing tasks received from the host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from the front end 212 and ensures that general processing clusters (GPCs) 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, the PPU 202 implements a highly parallel processing architecture based on a processing cluster array 230 that includes a set of C GPCs 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of the PP memory 204.

In one embodiment, a given GPC 208 may process data to be written to any of the DRAMs 220 within the PP memory 204. In one embodiment, the crossbar unit 210 is configured to route the output of each GPC 208 to the input of any partition unit 215 or to any other GPC 208 for further processing. The GPCs 208 communicate with the memory interface 214 via the crossbar unit 210 to read from or write to various DRAMs 220. In some embodiments, the crossbar unit 210 has a connection to the I/O unit 205, in addition to a connection to the PP memory 204 via the memory interface 214, thereby enabling the processing cores within the different GPCs 208 to communicate with the system memory 104 or other memory not local to the PPU 202.

In the embodiment of FIG. 2, the crossbar unit 210 is directly connected with the I/O unit 205. In various embodiments, the crossbar unit 210 may use virtual channels to separate traffic streams between the GPCs 208 and the partition units 215.

In one embodiment, the GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, the PPU 202 is configured to transfer data from the system memory 104 and/or the PP memory 204 to one or more on-chip memory units, process the data, and write result data back to the system memory 104 and/or the PP memory 204. The result data may then be accessed by other system components, including the CPU 102, another PPU 202 within the parallel processing subsystem 112, or another parallel processing subsystem 112 within the computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, the GPC 208 includes, without limitation, a pipeline manager 305, one or more texture units 315, a preROP unit 325, a work distribution crossbar 330, and an L1.5 cache 335.

In one embodiment, the GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of the GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, the GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In some embodiments, a single SM 310 may simultaneously support multiple CTAs, where such CTAs are at the granularity at which work is distributed to the SMs 310.

In one embodiment, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2

caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Generating Code With Integrated Abstract Syntax Tree-based Waveform Tracing

FIG. 4 is a more detailed illustration of the code generator 130 of FIG. 1, according to various embodiments. As shown, the code generator 130 includes, without limitation, a high-level planner agent 404; a circuit signal, transition, example extraction agent 408; a task and circuit relation graph construction module 412, a graph retrieval agent 416, a coding agent 420, and a debugging agent 424. The code generator 130 is an application that uses artificial intelligence (AI) agents, including the agents 404, 408, 416, 420, and 424, to generate and debug program code in a hardware description language. Each of the agents 404, 408, 416, 420, and 424 is a system configured to autonomously perform one or more actions to accomplish one or more tasks. In some embodiments, each agent described herein (e.g., each of agents 404, 408, 416, 420, and 424) can include one or more trained machine learning models, such as one or more trained language models (e.g., large language model(s)), multimodal models, and/or reasoning models that are prompted to perform one or more tasks, and the trained machine learning model(s) can also have access to one or more tools. In such cases, the trained machine learning model(s) can execute locally on the computer system 100, or the trained machine learning model(s) can execute elsewhere, such as in a cloud computing environment from which the trained machine learning model(s) are accessed via an application programming interface (API). In some embodiments, each agent can also include a memory that stores an original query and several last chats (e.g., six last chats) in a chat history.

In operation, the code generator 130 takes as input a natural language description of a hardware module 402 (also referred to herein as “natural language description 402”). For example, in some embodiments, the natural language description 402 can include description of circuitry that is input by a user via a user interface (UI).

The high-level planner agent 404 processes the natural language description 402 to generate a high-level plan 406 for generating program code for the module in a hardware description language. In some embodiments, the high-level planner agent 404 can generate the high-level plan 406 by breaking the natural language description 402 into one or more manageable sub-tasks considering the circuit architecture and functionality specified by the natural language description 402. For example, the sub-tasks(s) could include a first sub-task of implementing an interface of the hardware module and other sub-tasks of implementing other functionality of the hardware module. In parallel, the circuit signal, transition, example extraction agent 408 processes the natural language description 402 to extract low-level circuit information 410 on details of the hardware module. The task and circuit relation graph construction module 412 processes the high-level plan 406 and the extracted low-level circuit information 410 to generate a task and circuit relation graph 414. The graph retrieval agent 416 reasons and interacts with a retrieval tool (not shown) to retrieve, from the task and circuit relation graph 414, low-level circuit information that is relevant to each sub-task in the high-level plan 406, and the graph retrieval agent 416 generates a task plan 418 that includes the high-level plan 406 enriched with the retrieved low-level circuit information. In some embodiments, the task plan 418 can include one or more sub-tasks that are represented as nodes of a graph that can be executed in a step-by-step manner. The coding agent 420 generates initial code 422 according to the task plan 418. The debugging agent 424 debugs the initial code 422 to generate program code for the module 426 (also referred to herein as “program code 426”). The program code 426 is in a hardware description language, such as Verilog. Although described herein primarily with respect to Verilog as a reference example of a hardware description language, techniques disclosed herein can be applied to generate program code in any suitable hardware description languages, such as VHDL (VHSIC Hardware Description Language), Bluespec, etc.

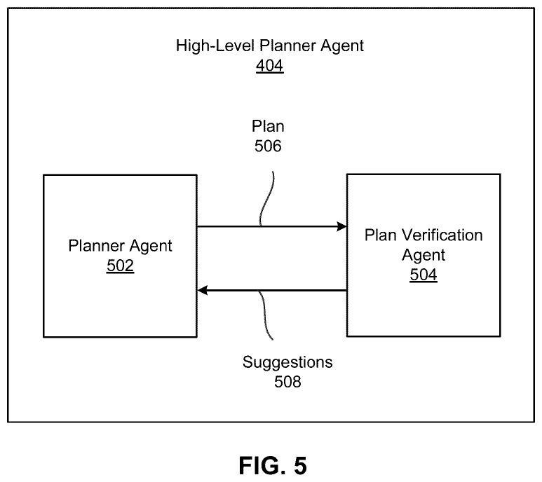

The high-level planner agent 404 receives the natural language description 402 and generates the high-level plan 406. In some embodiments, the high-level plan 406 includes a set of sub-tasks for performing a programming task specified by the natural language description 402. As discussed in greater detail below in conjunction with FIG. 5, in some embodiments, the high-level planner agent 404 implements multi-agent debating in which a planner agent (not shown) generates a plan, a plan verification agent (not shown) acts as a critic that verifies the generated plan, and the foregoing steps are repeated iteratively until a plan has been generated that is consistent with the natural language description 402.

The circuit signal, transition, example extraction agent 408 extracts low-level circuit information 410 from the natural language description 402, such as circuit signals, state transitions (including state transitions caused by signal transitions), and signal examples. In some embodiments, the circuit signal, transition, example extraction agent 408 can be provided (e.g., via a prompt) with guidelines on, e.g., what kind of attributes define the low-level circuit information 410, and the circuit signal, transition, example extraction agent 408 extracts such attributes from the natural language description 402. In some embodiments, the circuit signal, transition, example extraction agent 408 can output the low-level circuit information 410 as a knowledge graph in a structured format, such as JavaScript Object Notation (JSON) format. Accordingly, the unstructured natural language description 402 is converted to a structured knowledge graph.

The task and circuit relation graph construction module 412 uses (1) the high-level plan 406 generated by the high-level planner agent 404, and (2) the low-level circuit information 410 (e.g., circuit signals, state transitions, and signal examples) extracted by the circuit signal, transition, and example extraction agent 408 to generate the task and circuit relation graph 414. In some embodiments, the task and circuit relation graph 414 is a knowledge graph including nodes that represent sub-tasks of the high-level plan 406 and the extracted low-level circuit information 410, as well as edges between the nodes. In such cases, the high-level plan generated by the high-level planner agent 404 and the low-level circuit information 410 extracted by the circuit signal, transition, and example extraction agent 408 can be represented as nodes, as well as to determine relationships (edges) between the nodes, which together form the task and circuit relation graph 414.

The graph retrieval agent 416 retrieves, from the task and circuit relation graph 414, information that is relevant to each sub-task in the high-level plan 406. In some embodiments, the graph retrieval agent 416 reasons and interacts with a retrieval tool (not shown) to retrieve, from the task and circuit relation graph 414 and using a breadth-first search technique, low-level circuit information that is relevant to the natural language description 402, and the graph retrieval agent 416 generates the task plan 418 that includes the high-level plan 406 enriched with the retrieved low-level circuit information, such as relevant circuit signals, state transitions, and signal examples (i.e., circuit and signal descriptions). In some embodiments, the task plan 418 can be in the form of a graph. In such cases, the task plan 418 can include one or more sub-tasks that are represented as nodes of a graph that can be executed in a step-by-step manner, and the retrieved low-level circuit information can be stored in the nodes of the associated sub-tasks.

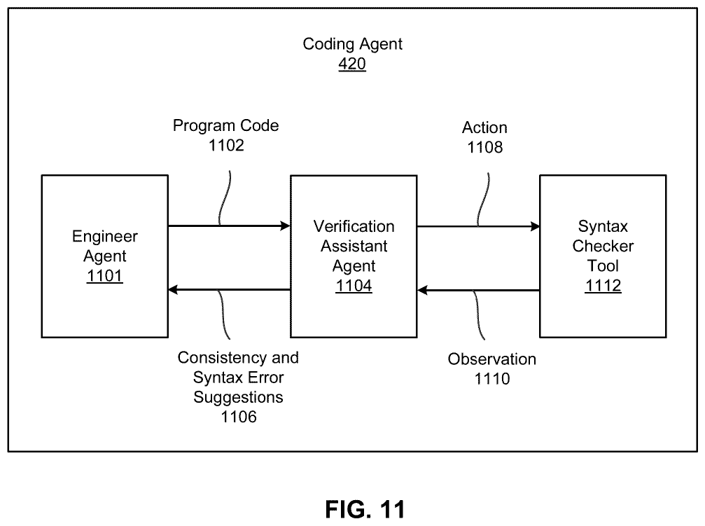

The coding agent 420 (1) generates, for each sub-task in the task plan 418, program code in a hardware description language (e.g., Verilog) using the low-level circuit information for the sub-task in the task plan 418; and (2) corrects syntax errors in the generated code, if any, to generate the initial code 422. As discussed in greater detail below in conjunction with FIG. 11, in some embodiments, the coding agent 420 implements multi-agent debating in which an engineer agent (not shown) generates, for each sub-task, program code in the hardware description language and a verification assistant agent (not shown) acts as a critic that uses a syntax checker tool to determine consistency and syntax errors in the program code, which the engineer agent can then correct, and the foregoing steps are repeated iteratively until program code has been generated for the sub-task that does not include syntax errors. By processing nodes of the task plan 418 graph that represent sub-tasks in a step-by-step manner, the coding agent 420 can generate the initial code 422 for the entire hardware module.

The debugging agent 424 verifies the syntax and functionality of the initial code 422 and, if syntax and/or functional errors are identified, debugs the initial code 422 to generate the program code 426. Functional errors can include differences between functionality implemented by the initial code 422 and functionality specified by the natural language description 402. In some embodiments, the debugging agent 424 uses a simulator tool (not shown) to check the syntax and functionality of the initial code 422. Then, the debugging agent 424 creates an abstract syntax tree (AST) that is a tree data structure, and in particular a data signal structure, for storing the simulation results generated by the simulator tool. For each mismatched output signal that is identified by the simulator tool, the debugging agent 424 inputs the mismatched output signal and a desired back-tracing level into a waveform tracing tool (not shown) that starts from the mismatched signal and iteratively extracts RVALUE (right-hand side value) signals until the specified back-tracing level is reached in the AST. The waveform tracing tool outputs the program code for reference, a tabular waveform of the mismatched signal, and the extracted RVALUE signals, which the debugging agent 424 uses to perform reasoning through a thought-action-observation process to generate new program code in the hardware description language, until code that passes the functionality test is generated and output as the program code 426.

FIG. 5 is a more detailed illustration of the high-level planner agent 404 of FIG. 4, according to various embodiments. As shown, the high-level planner agent 404 includes, without limitation, a planner agent 502 and a plan verification agent 504. In some embodiments, the high-level planner agent 404 implements multi-agent debating in which the planner agent 502 generates a plan (e.g., plan 506), the plan verification agent 504 acts as a critic that verifies the generated plan, and the foregoing steps are repeated iteratively until a plan has been generated that is consistent with a natural language description of a hardware module (e.g., natural language description 402). In some embodiments, the generated high-level plan includes a set of sub-tasks for performing a programming task specified by the natural language description.

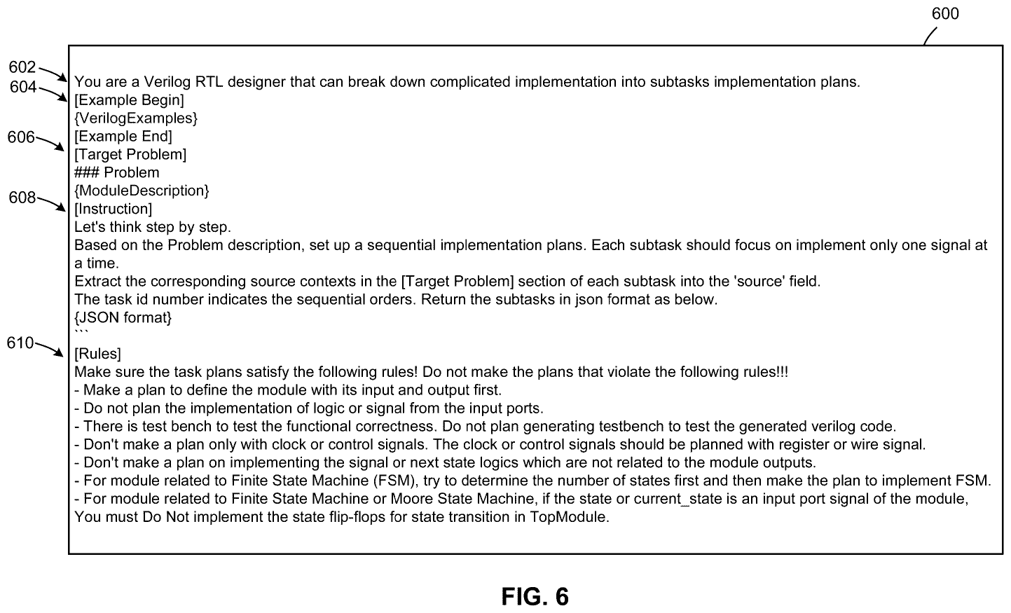

The planner agent 502 is an AI agent that generates a high-level plan (e.g., plan 506) given a natural language description of a hardware module. In some embodiments, given a natural language description of the hardware module, the planner agent 502 decomposes the natural language description into sub-tasks that are each a high-level plan description. In some embodiments, the planner agent 502 can include or have access to a trained machine learning model, such as a trained language model (e.g., a large language model), multimodal model, or reasoning model, that is prompted to generate the high-level plan based on the natural language description of the hardware module. An example prompt that can be input into the planner agent 502 is discussed in greater detail below in conjunction with FIG. 6.

The plan verification agent 504 is an AI agent that verifies a plan (e.g., plan 506) generated by the planner agent 502 for consistency with the natural language description of a hardware module, from which the plan was generated. In some embodiments, the plan verification agent 504 checks the consistency between sub-tasks of the plan generated by the planner agent 502 and the natural language description, providing suggestions (shown as suggestions 508) to modify the plan if any inconsistencies are found. In some embodiments, the plan verification agent 504 can include or have access to a trained machine learning model, such as a trained language model (e.g., a large language model), multimodal model, or reasoning model, that is prompted to verify the plan generated by the planner agent 502.

The planner agent 502 generates plans, and the plan verification agent 504 verifies the generated plans and provide suggestions for modifying the plans, until a high-level plan is generated that is consistent with the natural language description of the hardware module that the code generator 130 received as input.

FIG. 6 illustrates an exemplar prompt for the high-level planner agent 404 of FIG. 4, according to various embodiments. As shown, a prompt 600 includes, without limitation, a system message 602, examples 604 of program code in a hardware description language, a problem 606 to be solved, instructions 608, and rules 610. The prompt 600 can be input into a trained machine learning model (e.g., a trained language model) included in the planner agent 502, described above in conjunction with FIG. 5, to generate a high-level plan.

The system message 602 describes a role of the trained machine learning model as “You are a Verilog RTL designer that can break down complicated implementation into subtasks implementation plans.” The examples 604 provide examples of program code in a hardware description language, shown as Verilog. The problem 606 includes a natural language description of a hardware module, which can be received from a user via, e.g., a UI. The instructions 608 include step-by-step instructions for breaking down the natural language description from the problem 606 into sub-tasks and returning the sub-tasks in a structured format, shown as JSON. The rules 610 define constraints on the plans generated by the planner agent 502, including “Make a plan to define the module with its input and output first,” “Do not plan the implementation of logic or signal from the input ports,” and “Don't make a plan only with clock or control signals. The clock or control signals should be planned with register or wire signal.” Rules in prompts, such as the rules 610, can help a trained machine learning model (e.g., a language model) to avoid generating code with unnecessary syntax errors. It should be noted that stronger machine learning models may require fewer rules in some embodiments.

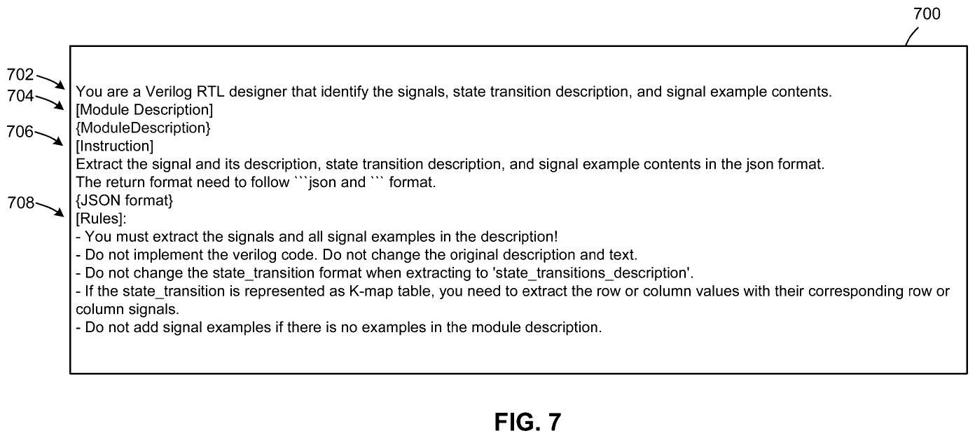

FIG. 7 illustrates an exemplar prompt for the circuit signal, transition, example extraction agent 408 of FIG. 4, according to various embodiments. As shown, a prompt 700 includes, without limitation, a system message 702, a description 704 of the hardware module, instructions 706, and rules 708. The prompt 700 can be input into a trained machine learning model (e.g., a trained language model) included in the circuit signal, transition, example extraction agent 408, described above in conjunction with FIG. 4, to extract low-level circuit information, such as circuit signals, state transitions, and signal examples.

The system message 702 describes a role of the trained machine learning model in the circuit signal, transition, example extraction agent 408 as “You are a Verilog RTL designer that identify the signals, state transition description, and signal example contents.” The description 704 includes a natural language description of a hardware module, which can be received from a user via, e.g., a UI. The instructions 706 instruct the machine learning model to “Extract the signal and its description, state transition description, and signal example contents” in a structured format, shown as a JSON format. In some embodiments, the instructions 706 can provide guidelines on, e.g., what kind of attributes define low-level circuit information that need to be extracted. The rules 708 also guide the machine learning model in extracting the low-level circuit information.

Given the prompt 700, the machine learning model in the circuit signal, transition, example extraction agent 408 can act as an engineer agent that extracts low-level circuit information, which includes circuit signals, state transitions, and signal examples, from the description of the hardware module into the structured format. As described, the extracted low-level circuit information can be represented as nodes of a task and circuit relation graph (e.g., task and circuit relation graph 414). Examples of extracted signals, state transitions, and signal examples are “w: input signal examined by FSM in state B”, “State A to State B: FSM moves to state B when s=1.”, and “For example, when the input w=1, 1, 0 in these three clock cycles, output z is set to 1 for the following cycle.”, respectively. For example, using the extracted low-level circuit information, the task and circuit relation graph construction module 412 can create nodes from a previously generated high-level description of sub-tasks in a high-level plan generated by the high-level planner agent 404, extracted circuit signals, state transitions, and signal examples. In some embodiments, the task and circuit relation graph construction module 412 can sequentially create the relations (edges) between nodes: sub-task nodes to signal nodes, signal nodes to transition nodes, and signal nodes to example nodes, using “IMPLEMENTS”, “SIGNALTRANSITION”, and “EXAMPLES” relationships, respectively, thereby generating a knowledge graph. In some embodiments, the circuit signal, transition, example extraction agent 408 can output the knowledge graph in a structured format, such as JSON format. Accordingly, an unstructured natural language description of a hardware module can be converted to a structured knowledge graph.

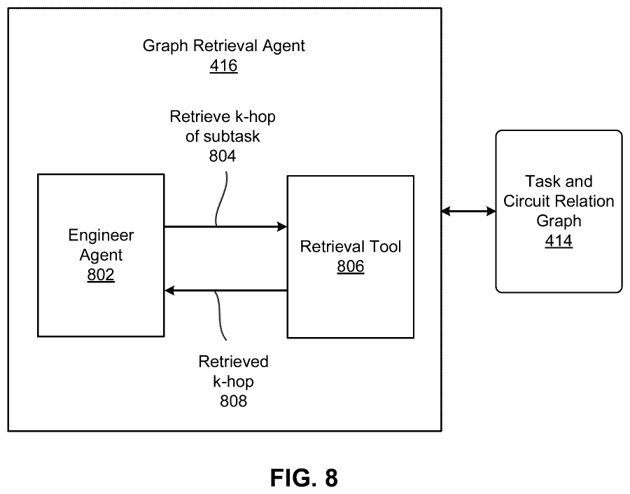

FIG. 8 is a more detailed illustration of the graph retrieval agent 416 of FIG. 4, according to various embodiments. As shown, the graph retrieval agent 416 includes, without limitation, an engineer agent 802 and a retrieval tool 806. In operation, the engineer agent 802 invokes the retrieval tool 806 to retrieve, from the task and circuit relation graph 414, low-level circuit information that is relevant to each sub-task in a high-level plan (e.g., high-level plan 406). In some embodiments, the engineer agent 802 uses the retrieval tool 806 to retrieve a number of hops from the sub-task, shown as retrieving k-hops from the subtask 804, and the retrieval tool 806 returns the retrieved number of hops, shown as retrieved k-hops 808, to the engineer agent 802. In some embodiments, for each sub-task, the engineer agent 802 reasons and interacts with the retrieval tool 806 to retrieve, from the task and circuit relation graph 414 and using a breadth-first search technique that iterative retrieves more hops from the task and circuit relation graph 414 until the engineer agent 802 determines that sufficient low-level circuit information is retrieved for implementing the sub-task, such as implementing an S-next signal. Using the retrieved k-hops, the engineer agent 802 generates a task plan (e.g., task plan 418) that includes the high-level plan 406 enriched with the retrieved low-level circuit information, such as relevant circuit signals, state transitions, and text examples. In some embodiments, the task plan can be in the form of a graph. In such cases, the task plan 418 can include one or more sub-tasks that are represented as nodes of the graph that can be executed in a step-by-step manner.

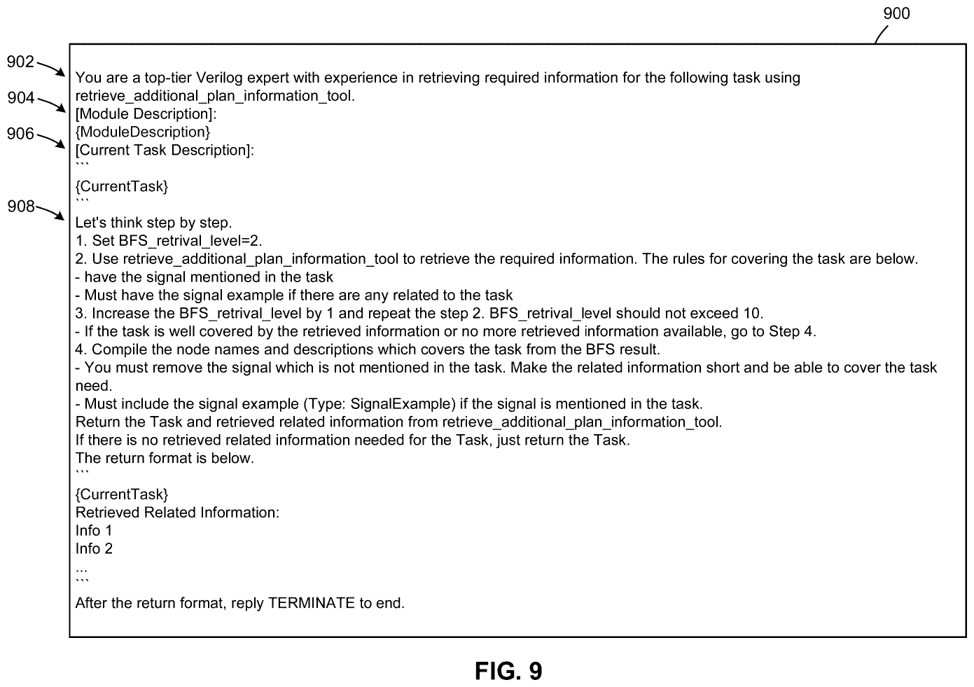

The engineer agent 802 is an AI agent that retrieves relevant low-level circuit information that is relevant to a sub-task in a task and circuit relation graph (e.g., task and circuit relation graph 414). In some embodiments, the engineer agent 802 can include or have access to a trained machine learning model, such as a trained language model (e.g., a large language model), multimodal model, or reasoning model, that is prompted to retrieve the relevant low-level circuit information. An example prompt that can be input into the engineer agent 802 of the graph retrieval agent 416 is discussed in greater detail below in conjunction with FIG. 9. In such cases, the trained machine learning model, acting as the engineer agent 802, autonomously retrieves relevant low-level circuit information, such as signal and circuit descriptions, from the task and circuit relation graph 414 and compiles the retrieved low-level circuit information for each sub-task using the retrieval tool 806 through thought-action-observation ReAct tracing that performs a breadth-first search.

The retrieval tool 806 assists the graph retrieval agent 416 in obtaining relevant low-level circuit information, such as descriptions or definitions of signals, state transitions, and signal examples, that are related to a specific sub-task in the task and circuit relation graph (e.g., task and circuit relation graph 414). Although shown as being inside the graph retrieval agent 416 for illustrative purposes, in some embodiments, the retrieval tool 806 can be distinct from the graph retrieval agent and accessed via, e.g., an API. In some embodiments, the inputs to the retrieval tool 806 are the sub-task description in string format and an integer value, k, which indicates the number of hops for retrieval from the sub-task node in the task and circuit relation graph. Here, k is determined by the engineer agent 802 automatically through the thought-action-observation reasoning trace described above. In some embodiments, the output of the retrieval tool 806 includes the retrieved k-hop low-level circuit information (e.g., retrieved k-hop of sub-task 808), such as retrieved k-hop signals, state transitions, and signal examples, corresponding to the sub-task node. The engineer agent 802 reasons and interacts with the retrieval tool 806 to incorporate additional retrieved information. The engineer agent 802 continues retrieving low-level circuit information until the engineer agent 802 determines that enough information has been retrieved to implement the sub-task. Ultimately, the retrieval tool 806 compiles the retrieved low-level circuit information (e.g., circuit and signal information) from the graph and removes irrelevant information from the final answer.

FIG. 9 illustrates an exemplar prompt for the graph retrieval agent 416 of FIG. 4, according to various embodiments. As shown, a prompt 900 includes, without limitation, a system message 902, a description 904 of a hardware module, a task description 906, and step-by-step instructions 908. The prompt 900 can be input into a trained machine learning model (e.g., a trained language model) included in the engineer agent 802, described above in conjunction with FIG. 8, to generate a high-level plan.

The system message 902 describes a role of the trained machine learning model as “You are a top-tier Verilog expert with experience in retrieving required information for the following task using retrieve_additional_plan_information_tool.” The description 904 includes a natural language description of a hardware module, which can be received from a user via, e.g., a UI. The task description 906 is a variable that can describe various tasks to perform. The step-by-step instructions 908 include instructions for thought-action-observation ReAct tracing to retrieve relevant low-level circuit information, such as signal and circuit descriptions, from a task and circuit relation graph 414 (e.g., task and circuit relation graph 414) and compile the retrieved low-level circuit information for each sub-task of a high-level plan, as described above in conjunction with FIG. 8.

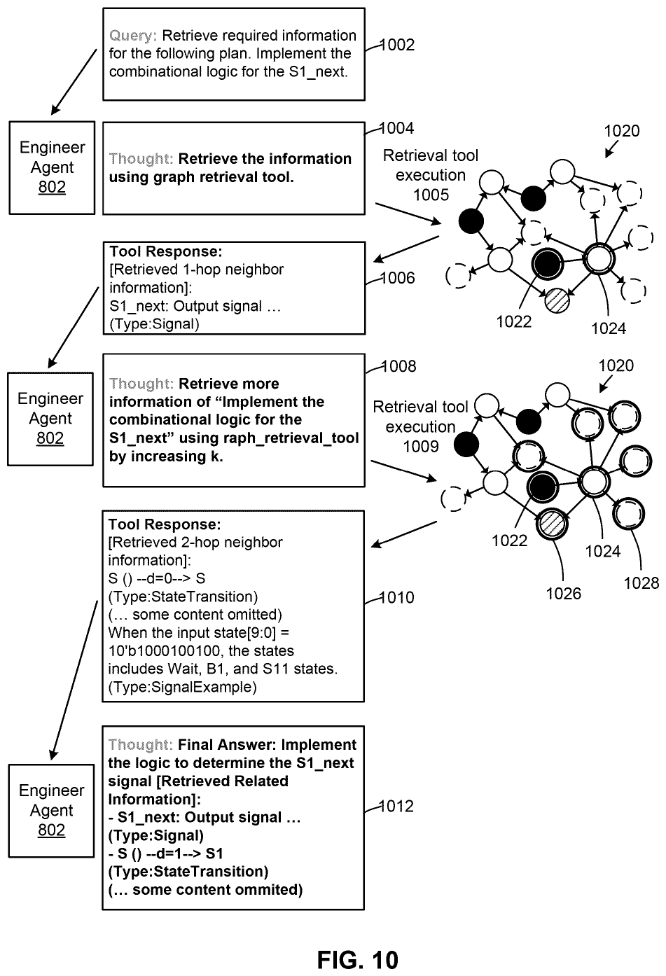

FIG. 10 illustrates exemplar reasoning of the engineer agent 802 and interactions with the retrieval tool 806 of FIG. 8, according to various embodiments. As shown, in response to receiving a query 1002 for a sub-task of “Retrieve required information for the following plan. Implement the combinational logic for the S1_next,” which can be included in a prompt (e.g., the prompt 900), the engineer agent 802 performs thought-action-observation ReAct tracing to retrieve relevant low-level circuit information, such as signal and circuit descriptions, from an example task and circuit relation graph 1020.

Illustratively, the task and circuit relation graph 1020 includes (1) three nodes, shown as filled in circles, that represent sub-tasks of a high-level plan (e.g., sub-task node 1022); (2) four nodes, shown as circles, that represent signals (e.g., signal node 1024); (3) six nodes, shown as ghosted circles, that represent state transitions (e.g., state transition node 1028); and (4) one node, shown with a pattern fill, that represents a signal example (signal transition node 1026). The engineer agent 802 performs thought-action-observation ReAct tracing to retrieve, from the task and circuit relation graph 1020, low-level circuit information that is relevant to the sub-task in the query 1002. The thought-action-observation ReAct tracing performs a breadth-first search by determining an integer value, k, which indicates the number of hops for retrieval from the sub-task node in the task and circuit relation graph 1020, invoking the retrieval tool 806 to retrieve the k number of hops that include low-level circuit information such as circuit and signal descriptions, determining whether the retrieved low-level circuit information is sufficient to generate program code for the sub-task, and, if the retrieved low-level circuit information is not sufficient, iteratively repeating the foregoing steps with increased k numbers of hops until sufficient low-level circuit information is retrieved.

Illustratively, the engineer agent 802 first has a thought 1004 to “Retrieve the information using graph retrieval tool.” Then, the engineer agent 802 invokes the retrieval tool 802 to retrieve 1-hop neighbor information from the task and circuit relation graph 1020, shown as retrieval tool execution 1005, that results in a tool response 1006 including information for the signal node 1024 that is one hop from the sub-task node 1022. Upon determining the retrieved low-level circuit information in the tool response 1006 is not sufficient to generate program code for the sub-task, the engineer agent 802 has the thought 1008 “Retrieve more information of “Implement the combinational logic for the S1_next” using raph_retrieval_tool by increasing k.” Then, the engineer agent 802 invokes the retrieval tool 806 again to retrieve 2-hop neighbor information from the task and circuit relation graph 1020, shown as retrieval tool execution 1009 that results in a tool response 1010 including information for the state transition and signal example nodes (e.g., state transition node 1028 and signal example node 1026) that are two hops from the sub-task node 1022. Upon determining the retrieved low-level circuit information in the tool response 1010 is sufficient to generate program code for the sub-task, the engineer agent 802 enriches the sub-task with the relevant low-level circuit information, shown as relevant circuit and signal descriptions enriching the sub-task in a final answer of thought 1012.

FIG. 11 is a more detailed illustration of the coding agent 420 of FIG. 4, according to various embodiments. As shown, the coding agent 420 includes, without limitation, an engineer agent 1101, a verification assistant agent 1104, and a syntax checker tool 1112. The engineer agent 1101 is an AI agent having the same role as the engineer agent 802 of the graph retrieval agent 416, described above in conjunction with FIG. 8. In some embodiments, the engineer agent 1101 can be identical to or different from the engineer agent 802. In operation, the engineer agent 1101 generates program code 1102 in a hardware description language (e.g., Verilog) based on the low-level circuit information for a sub-task (e.g., a sub-task in the task plan 418), and the verification assistant agent 1104, which is another AI agent, invokes the syntax checker tool 1112 to determine consistency and syntax errors in the program code 1102 and provide suggestions to correct the program code 1102 to the engineer agent 1101, shown as consistency and syntax error suggestions 1106. Then, the engineer agent 1101 corrects the consistency and syntax errors, if any, to generate new program code, and the foregoing steps can be repeated any number of times until program code is generated that does not include consistency or syntax errors. That is, the coding agent 420 can implement multi-agent debating in which the engineer agent 1101 generates, for each sub-task, program code in the hardware description language and the verification assistant agent 1104 acts as a critic that uses the syntax checker tool 1112 to determine consistency and syntax errors in the program code, which the engineer agent 1101 can then correct. In some embodiments, the coding agent 420 performs reasoning through a thought-action-observation ReAct process, shown as action 1108 and observation 1110, to iteratively correct syntax errors in generated program code. By processing nodes of the graph in a task plan (e.g., task plan 418) that represent sub-tasks in a step-by-step manner, the coding agent 420 can generate the program code for an entire hardware module. In some embodiments, multiple coding agents 420 can execute to generate program code for two or more sub-tasks in parallel, depending on the graph topology of the task plan.

In some embodiments, each of the engineer agent 1101 and the verification assistant agent 1104 can include or have access to a trained machine learning model, such as a trained language model (e.g., a large language model), multimodal model, or reasoning model. The engineer agent 1101 writes program code (e.g., program code 1102) in a hardware description language according to a sub-task in a task plan (e.g., task plan 418) for generating code for a natural language description of a hardware module (e.g., natural language description 402). The verification assistant agent 1104 ensures that the written program code is consistent with the sub-task requirements and free of syntax errors using the syntax checker tool 1112. The syntax checker tool 1112 is a tool that can be invoked to compile program code and provide compiled messages as feedback for syntax checking. Any technically feasible syntax checker tool 1112, such as iverilog, can be used in some embodiments. If there are syntax errors or inconsistencies between the written program code and the sub-task description, the verification assistant agent 1104 will provide suggestions (e.g., consistency and syntax error suggestions 1106) to the engineer agent 1101 for fixing the issues. The foregoing process continues iteratively between the engineer agent 1101 and the verification assistant agent 1104 until the generated program code is free of syntax errors and consistent with the sub-task description, and the same process can be repeated to generate program code for each sub-task. In some embodiments, the coding agent 420 can perform reasoning through a thought-action-observation ReAct process, described above. In some embodiments, a child sub-task in the graph of the task plan 418 cannot be executed until all parent sub-tasks of the child sub-task have been completed without errors. In some embodiments, sub-tasks are divided into two types: (1) Type1: writing program code in the hardware description language for partial function/logic, and (2) Type2: verifying and debugging the generated hardware module. In such cases, the coding agent 420 and the debugging agent 424 are assigned to complete the Type1 sub-task and Type 2 sub-task, respectively.

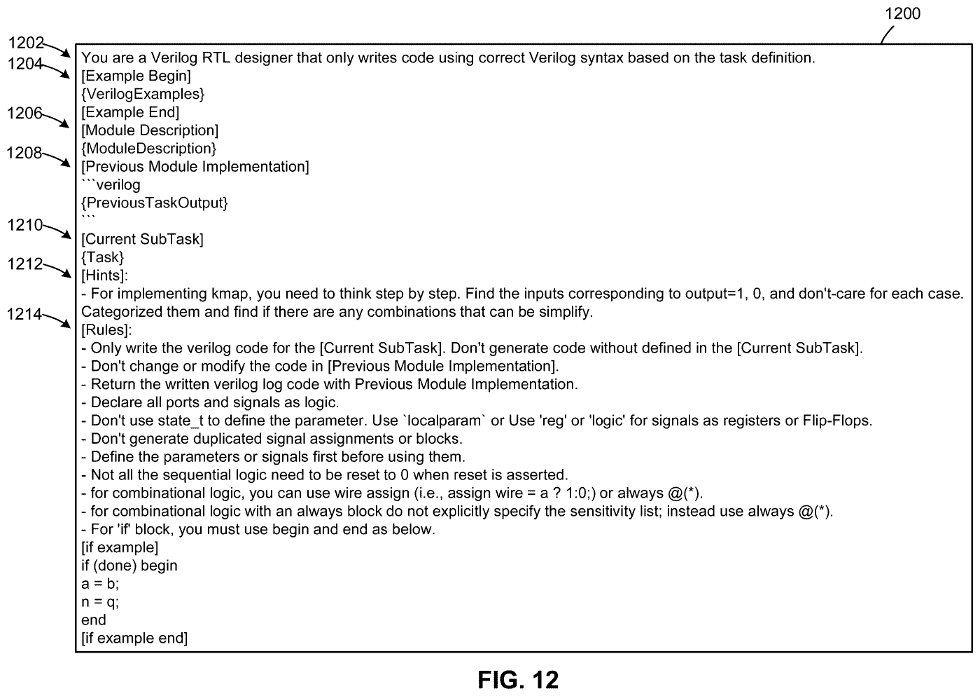

FIG. 12 illustrates an exemplar prompt for the coding agent 420 of FIG. 4, according to various embodiments. As shown, a prompt 1200 includes, without limitation, a system message 1202, examples 1204 of program code in a hardware description language, a description 1206 of a hardware module, a previous module implementation 1208, a current sub-task 1210, hints 1212, and rules 1214. The prompt 900 can be input into a trained machine learning model (e.g., a trained language model) included in the engineer agent 1101, described above in conjunction with FIG. 11, to generate a program code in a hardware description language.

The system message 1202 describes a role of the trained machine learning model as “You are a Verilog RTL designer that only writes code using correct Verilog syntax based on the task definition.” The examples 1204 provide examples of program code in the hardware description language, shown as Verilog. The description 1206 includes a natural language description of a hardware module, which can be received from a user via, e.g., a UI. The previous module implementation 1208 includes previous program code that the engineer agent 1101 generated, which may have syntax errors identified by the verification assistant agent 1104. The current sub-task 1210 describes the current subtask to perform. The hints 1212 and the rules 1214 are used to guide the engineer agent 1101 in generating program code in the hardware description language.

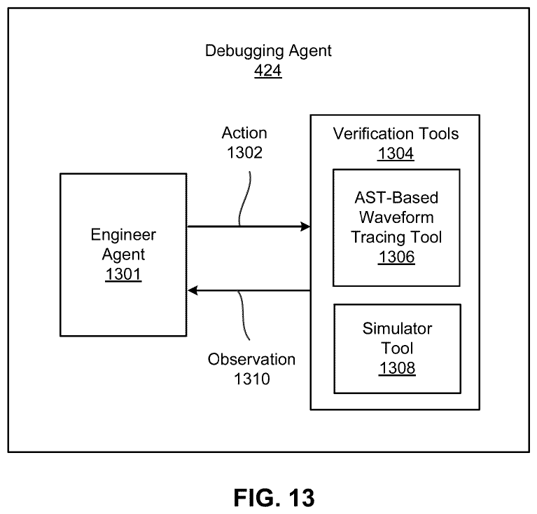

FIG. 13 is a more detailed illustration of the debugging agent 424 of FIG. 4, according to various embodiments. As shown, the debugging agent 424 includes, without limitation, the engineer agent 1301 and verification tools 1304. The verification tools 1304 include, without limitation, an AST-based waveform tracing tool 1306 and a simulator tool 1308. In operation, the debugging agent 424 verifies the syntax and functionality of program code that is generated by the coding agent 420 (e.g., initial code 422) and, if syntax and/or functional errors are identified, the debugging agent 424 debugs the program code. As described, functional errors can include differences between functionality implemented by generated program code and functionality specified by a natural language description. In some embodiments, the engineer agent 1301 invokes the simulator tool 1308 to check the functionality of program code (e.g., initial code 422) that is generated by the coding agent 420. Then, the debugging agent 424 (e.g., the engineer agent 1301 in the debugging agent 424) creates an AST that stores the simulation results. The engineer agent 1301 inputs a mismatched output signal that is identified by the simulator tool 1308 and a desired back-tracing level into the waveform tracing tool 1306, which starts from the mismatched signal and iteratively extracts RVALUE signals until the specified back-tracing level is reached in the AST. The waveform tracing tool 1306 outputs a code reference, a tabular waveform of the mismatched signal, and the extracted RVALUE signals, which the engineer agent 1301 uses to perform reasoning through a thought-action-observation process, shown as action 1302 and observation 1310, to generate new code, until code that passes the functionality test is generated.

The simulator tool 1308 is a tool that can be invoked to compile program code for a hardware module in a hardware description language (e.g., Verilog) and launch a simulation of the hardware module. In some embodiments, the simulator tool 1308 accesses a testbench that provides a controlled environment or tool for verifying the functionality, performance, and reliability of the hardware module. Any technically feasible simulator tool 1308, such as iverilog, can be used in some embodiments. If the program code does not compile due to syntax errors, the simulator tool 1308 reports the lines where the syntax errors occur. The simulator tool 1308 also reports the simulation results, including the number of mismatches in output signals and the first mismatched time point. Additionally, the simulator tool 1308 generates a waveform table in, e.g., a value change dump (VCD) file format for waveform tracing.

The AST-based waveform tracing tool 1306 is a tool that can be invoked to assist in back-tracing the waveform of signals from mismatched output signals. Use of the AST-based waveform tracing tool 1306 is advantageous because machine learning models such as large language models can sometimes have difficulty understanding tree data structures such as ASTs. The AST of generated program code can be extracted in any technically feasible manner in some embodiments, such as using the Pyverilog library when the program code is Verilog code. By inputting the mismatched output signals from the simulator tool 1308 and the desired back-tracing level, the AST-based waveform tracing tool 1306 starts from the mismatched signal and iteratively extracts the RVALUE signals until the AST-based waveform tracing tool 1306 reaches the specified back-tracing level in the AST. The back-tracing level parameter is determined dynamically by the engineer agent 1301 through a thought-action observation reasoning trace. The output of the AST-based waveform tracing tool 1306 includes the program code for reference, a tabular waveform of the mismatched signal, and the extracted RVALUE signals.

The engineer agent 1301 is an AI agent having the same role as the engineer agent 802 of the graph retrieval agent 416 and the engineer agent 1101 of the coding agent 420, described above in conjunction with FIGS. 8 and 11, respectively. In some embodiments, the engineer agent 1101 can be identical to or different from the engineer agent 802 and the engineer agent 1101. In some embodiments, each of the engineer agent 1301 can include or have access to a trained machine learning model, such as a trained language model (e.g., a large language model), multimodal model, or reasoning model. In operation, the engineer agent 1301 uses the simulator tool 1308 and the AST-based waveform tracing tool 1306 to verify the functionality of generated program code (e.g., initial code 422) and modifies the program code to pass the functionality check from a provided testbench. In some embodiments, the engineer agent 1301 performs reasoning and interacts with the simulator tool 1308 and the AST-based waveform tracing tool 1306 through a thought-action-observation process, shown as action 1302 and observation 1310, to iteratively debug generated program code using traced waveform information until program code is generated that passes the functionality check. During the thought-action-observation process, the engineer agent 1301 can invoke the AST-based waveform tracing tool 1306 to trace RVALUE signals. The AST-based waveform tracing tool 1306 will iteratively extract the RVALUE signals until the AST-based waveform tracing tool 1306 reaches a back-tracing level in the AST that is specified by the engineer agent 1301. The AST-based waveform tracing tool 1306 will output the program code for reference, a tabular waveform of the mismatched signal, and the extracted RVALUE signals. In some embodiments, the AST-based waveform tracing tool 1306 can also output a hint telling the engineer agent 1301 that if the output information is not enough to identify a root cause and correct a functional error, then the engineer agent 1301 can trace more signals using a larger trace level, and otherwise the engineer agent 1301 should start correcting the functional error. Given such outputs, the engineer agent 1301 will either start correcting the functional error or invoke the AST-based waveform tracing tool 1306 again using a larger trace level, and the foregoing steps are repeated until program code is generated with no functional errors.

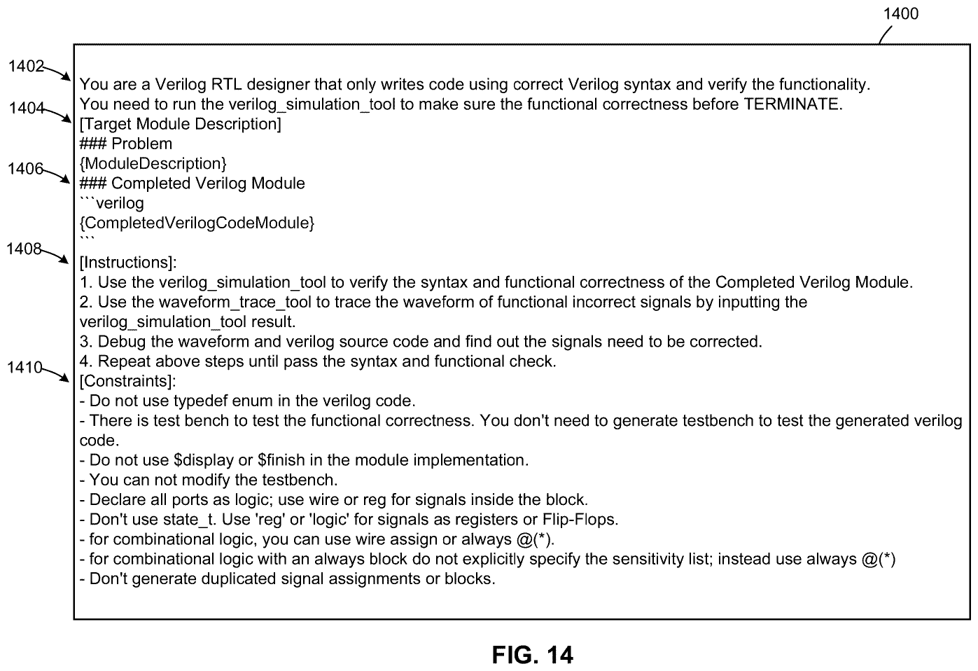

FIG. 14 illustrates an exemplar prompt for the debugging agent 424 of FIG. 4, according to various embodiments. As shown, a prompt 1400 includes, without limitation, a system message 1402, a description 1404 of a hardware module, program code 1406 for a hardware module in a hardware description language, step-by-step instructions 1408, and constraints 1410. The prompt 1400 can be input into a trained machine learning model (e.g., a trained language model) included in the engineer agent 1301, described above in conjunction with FIG. 13, to correct syntax and functional errors in program code (e.g., initial code 422) that is generated by the coding agent 420.

The system message 1402 describes a role of the trained machine learning model as “You are a Verilog RTL designer that only writes code using correct Verilog syntax and verify the functionality. You need to run the verilog_simulation_tool to make sure the functional correctness before TERMINATE.” The description 1404 includes a natural language description of a hardware module, which can be received from a user via, e.g., a UI. The program code 1406 includes program code in a hardware description language (e.g., initial code 422) that is generated by the coding agent 420. The step-by-step instructions 1408 include instructions for using the simulator tool 1308 and the AST-based waveform tracing tool 1306 to debug the program code 1406, as described above in conjunction with FIG. 13. The constraints 1410 are used to guide the engineer agent 1301 in debugging the program code 1406.

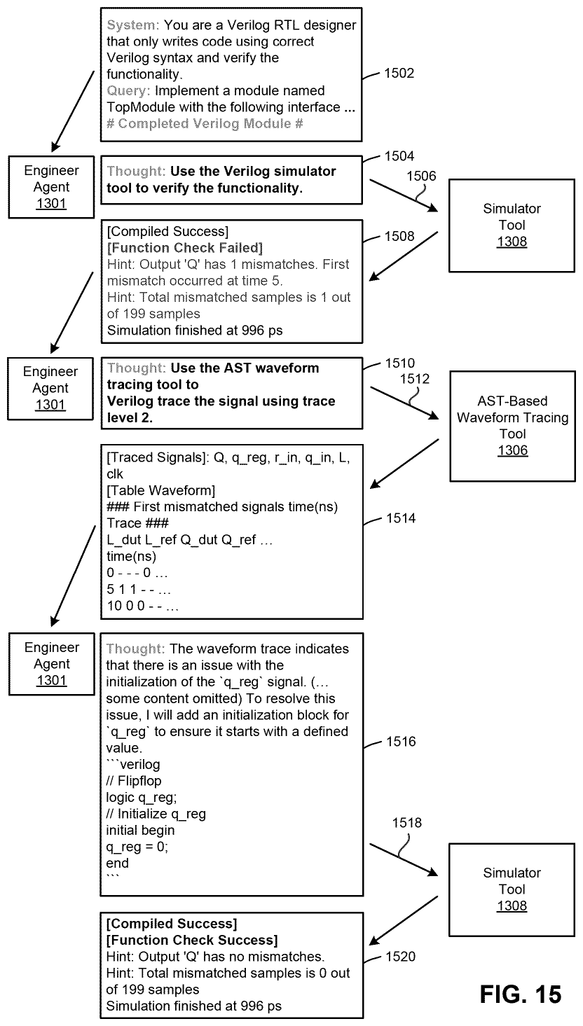

FIG. 15 illustrates exemplar reasoning of the engineer agent 1301 and interactions with the AST-based waveform tracing tool 1306 and the simulator tool 1308 of FIG. 13 to debug program code, according to various embodiments. The hardware description language is Verilog in this example. As shown, in response to receiving a prompt 1502, which asks the engineer agent 1301 to correct generated Verilog code for a hardware module and is similar to the prompt 1400 described above in conjunction with FIG. 14, the engineer agent 1301 generates a thought 1504 to “Use the Verilog simulator tool to verify the functionality.” Then, the engineer agent 1301 invokes 1506 the simulator tool 1308 to check the syntax and functionality of the Verilog code in the prompt 1502. Illustratively, an output 1508 of the simulator tool 1308 indicates that the Verilog code was compiled successfully, so there are no syntax errors, but a functional check failed due to one mismatched output signal. The engineer agent 1301 analyzes the output 1508 and generates another thought 1510 to “Use the AST waveform tracing tool to Verilog trace the signal using trace level 2.” After the debugging agent 424 creates an AST that stores the simulation results from the output 1508 of the simulator tool 1308, the engineer agent 1301 inputs 1512 the mismatched output signal that is identified by the output 1508 and the desired back-tracing level of 2 into the AST-based waveform tracing tool 1306, which starts from the mismatched signal and iteratively extracts RVALUE signals until the specified back-tracing level is reached in the AST. The waveform tracing tool 1306 generates an output 1514 that includes a code reference, a tabular waveform of the mismatched signal, and the extracted RVALUE signals, which the engineer agent 1301 uses to perform reasoning through a thought-action-observation process to generate updated program code, which would be Verilog code in this example. Illustratively, the engineer agent 1301 generates a thought 1516 and updated program code (not shown). Then, the engineer agent 1301 invokes 1518 the simulator tool 1308 again using the updated program code. Illustratively, the simulator tool 1308 generates an output 1520 indicating that the updated program code was compiled successfully and does not include functional errors.

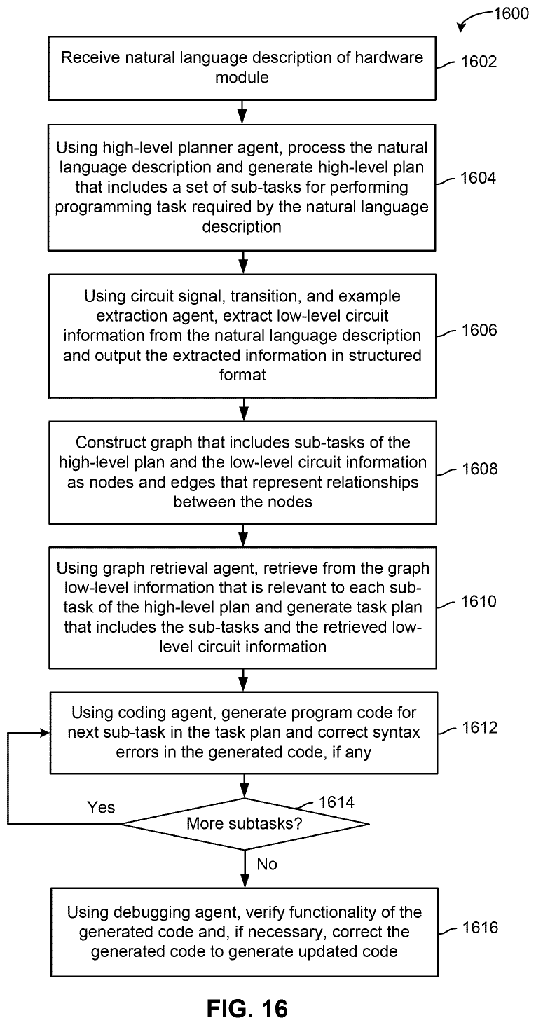

FIG. 16 is a flow diagram of method steps for generating program code in a hardware description language, according to various embodiments. Although the method steps are described in conjunction with the systems of FIGS. 1-15, persons skilled in the art will understand that any system configured to perform the method steps in any order falls within the scope of the present embodiments.

As shown, a method 1600 begins at step 1602, where the code generator 130 receives a natural language description of a hardware module (e.g. natural language description 402). In some embodiments, the natural language description can include description of circuitry that is input by a user via, e.g., a UI.

At step 1604, the high-level planner agent 404 processes the natural language description and generates a high-level plan (e.g., high-level plan 406) that includes a set of sub-tasks for performing the programming task specified by the natural language description. In some embodiments, the high-level planner agent 404 can generate the high-level plan by breaking the natural language description into one or more manageable sub-tasks considering the circuit architecture and functionality specified by the natural language description. In some embodiments, the high-level planner agent 404 implements multi-agent debating in which a planner agent (not shown) generates a plan, a plan verification agent (not shown) acts as a critic that verifies the generated plan, and the foregoing steps are repeated iteratively until a plan has been generated that is consistent with the natural language description, as described above in conjunction with FIGS. 5-6.

At step 1606, the circuit signal, transition, and example extraction agent 408 extracts low-level circuit information from the natural language description and outputs the extracted information in a structured format. In some embodiments, the circuit signal, transition, example extraction agent 408 can be provided (e.g., via a prompt) with guidelines on, e.g., what kind of attributes define the low-level circuit information, and the circuit signal, transition, example extraction agent 408 extracts such attributes from the natural language description, as described above in conjunction with FIG. 7. In some embodiments, the extracted low-level circuit information can include circuit signals, state transitions (including state transitions caused by signal transitions), and signal examples. In some embodiments, the extracted low-level circuit information can be output in a structured format, such as JSON format.

At step 1608, the task and circuit relation graph construction module 412 constructs a graph (e.g., task and circuit relation graph 414) that includes the sub-tasks of the high-level plan and the low-level circuit information as nodes and edges that represent relationships between the nodes. In some embodiments, the generated graph is a knowledge graph including nodes that represent sub-tasks of the high-level plan and the extracted low-level circuit information, as well as edges between the nodes. In such cases, the high-level plan generated by the high-level planner agent 404 and the low-level circuit information extracted by the circuit signal, transition, and example extraction agent 408 can be represented as nodes, as well as to determine relationships (edges) between the nodes, which together form the graph.

At step 1610, the graph retrieval agent 416 retrieves, from the graph, low-level circuit information that is relevant to each sub-task of the high-level plan and generates a task plan (e.g., task plan 418) that includes the sub-tasks and the retrieved low-level circuit information. In some embodiments, the engineer agent 802 in the graph retrieval agent 416 reasons and interacts with the retrieval tool 806 to retrieve, from the task and circuit relation graph 414 and using a breadth-first search technique, low-level circuit information that is relevant to the natural language description 402, and the engineer agent 802 generates the task plan 418 that includes the high-level plan 406 enriched with the retrieved low-level circuit information such as relevant circuit signals, state transitions, and signal examples (i.e., circuit and signal descriptions), as described above in conjunction with FIGS. 8-10. In some embodiments, the sub-tasks in the task plan can be represented as nodes of a graph that can be executed in a step-by-step manner.

At step 1612, the coding agent 420 generates program code in a hardware definition language for a next sub-task in the task plan and corrects syntax errors in the generated code, if any. The next sub-task is initially a first sub-task. In some embodiments, the coding agent 420 implements multi-agent debating in which the engineer agent 1101 generates, for each sub-task, program code in the hardware description language and the verification assistant agent 1104 acts as a critic that uses the syntax checker tool 1112 to determine consistency and syntax errors in the program code, which the engineer agent 1101 can then correct, and the foregoing steps are repeated iteratively until program code has been generated for the sub-task that does not include syntax errors, as described above in conjunction with FIGS. 11-12. By processing nodes of the task plan graph that represent sub-tasks in a step-by-step manner, the coding agent 420 can generate the program code for the entire hardware module.

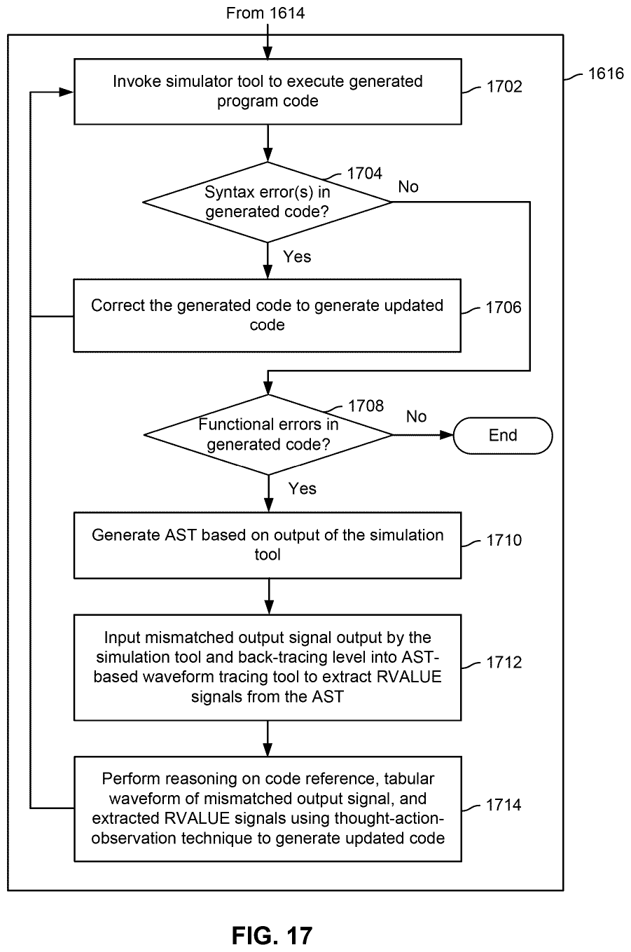

At step 1614, if there are more subtasks in the task, then the method 1600 returns to step 1612, where the coding agent 420 generates program code in the hardware definition language for a next sub-task in the task plan and corrects syntax errors in the generated code, if any. On the other hand, if there are no more subtasks in the task, then the method 1600 continues directly to step 1616, where the debugging agent verifies functionality of the generated code for the hardware module and, if necessary, corrects the generated code to generate updated code. Step 1616 is discussed in greater detail below in conjunction with FIG. 17.

FIG. 17 is a flow diagram of method steps for debugging program code in a hardware description language at step 1616 of the method 1600, according to various embodiments. Although the method steps are described in conjunction with the systems of FIGS. 1-15, persons skilled in the art will understand that any system configured to perform the method steps in any order falls within the scope of the present embodiments.

As shown, at step 1702, the engineer agent 1301 in the debugging agent 424 invokes the simulator tool 1308 to execute generated program code (e.g., initial code 422) in a hardware description language.

At step 1704, the engineer agent 1301 determines whether there are any syntax errors in the generated code. In some embodiments, the simulator tool 1308 can compile the generated code and output, to the engineer agent 1301, whether there are any compilation errors, which are syntax errors. If the engineer agent 1301 determines that there are one or more syntax errors in the generated code, then the method 1600 continues to step 1706, where the engineer agent 1301 corrects the generated code to generate updated code. Correcting the generated code can include prompting a trained machine learning model, such as a trained language model, to fix the syntax error(s) in the generated code, as described above in conjunction with FIGS. 14-15. After step 1706, the method 1600 returns to step 1702, where the engineer agent 1301 again invokes the simulator tool 1308 to execute the updated code.

On the other hand, if the simulator tool 1308 does not identify any syntax errors at step 1704, then the method 1600 proceeds directly to step 1708, where the engineer agent 1301 determines whether there are any functional errors in the generated code. In some embodiments, the simulator tool 1308 can also output functional errors in the generated code, if any, based on a simulation of the hardware module.

If there are no functional errors in the generated code, then the method 1600 ends. On the other hand, if there are one or more functional errors in the generated code, then the method 1600 continues to step 1710, where the engineer agent 1301 generates an AST based on the output of the simulator tool. The AST is a data signal structure that stores the simulation results generated by the simulator tool 1308.

At step 1712, the engineer agent 1301 inputs a mismatched output signal that is output by the simulator tool 1308 and a back-tracing level into the AST-based waveform tracing tool 1306 to extract RVALUE (right-hand side value) signals from the AST. In some embodiments, the AST-based waveform tracing tool 1306 starts from the mismatched signal and iteratively extracts RVALUE (right-hand side value) signals from the AST until the specified back-tracing level is reached, as described above in conjunction with FIGS. 13-15. In some embodiments, the AST-based waveform tracing tool 1306 outputs the program code for reference, a tabular waveform of the mismatched signal, and the extracted RVALUE signals.

At step 1714, the engineer agent 1301 performs reasoning on the reference program code, tabular waveform of the mismatched output signal, and the extracted RVALUE signals using a thought-action-observation technique to generate updated code. As described above in conjunction with FIGS. 13-15, in some embodiments, during the thought-action-observation process, the engineer agent 1301 can invoke the AST-based waveform tracing tool 1306 to trace RVALUE signals. The AST-based waveform tracing tool 1306 will iteratively extract the RVALUE signals until the AST-based waveform tracing tool 1306 reaches a back-tracing level in the AST that is specified by the engineer agent 1301. The AST-based waveform tracing tool 1306 will then output the program code for reference, a tabular waveform of the mismatched signal, and the extracted RVALUE signals. In some embodiments, the AST-based waveform tracing tool 1306 can also output a hint telling the engineer agent 1301 that if the output information is not enough to identify a root cause and correct a functional error, then the engineer agent 1301 can trace more signals using a larger trace level, and otherwise the engineer agent 1301 should start correcting the functional error. Given such outputs from the AST-based waveform tracing tool 1306, the engineer agent 1301 will either start correcting the functional error or invoke the AST-based waveform tracing tool 1306 again using a larger trace level.

After step 1714, the method 1600 returns to step 1702, where the engineer agent 1301 again invokes the simulator tool 1308 to execute the updated code.

In sum, techniques are disclosed for generating program code in a hardware description language, such as Verilog. In some embodiments, a high-level planner agent receives a natural language description of a hardware module and generates a high-level plan that includes a set of sub-tasks for programming the hardware module described by the natural language description. A circuit signal, transition, and example extraction agent extracts low-level circuit information, such as circuit signals, state transitions, and signal examples, from the natural language description and outputs the extracted information in a structured format. The sub-tasks in the high-level plan generated by the high-level planner agent and the low-level circuit information extracted by the circuit signal, transition, and example extraction agent are represented as nodes in a task-driven circuit relation graph that includes the nodes and edges between related nodes. A task-driven circuit relation graph retrieval agent retrieves, from the task-driven circuit relation graph, low-level circuit information that is relevant to each sub-task. The task-driven circuit relation graph retrieval agent augments the high-level plan with the retrieved low-level circuit information to generate a task plan in the form of a graph. A coding agent processes each sub-task in the task plan graph in a step-by-step manner to generate program code for the sub-task in the hardware description language, and the coding agent corrects syntax errors in the generated code until program code without syntax errors is generated. Then, a debugging agent verifies the syntax and functionality of the generated program code for the entire hardware module, and the debugging agent corrects syntax and functional errors in the generated code.

In some embodiments, the debugging agent uses a simulator tool to check the syntax and functionality of the generated code. Simulation results output by the simulator tool are used to create an AST. When functional errors are identified, the debugging agent inputs a mismatched output signal that is identified by the simulator tool and a desired back-tracing level into a waveform tracing tool that starts from the mismatched signal and iteratively extracts RVALUE signals until the specified back-tracing level is reached in the AST. The waveform tracing tool outputs the program code for reference, a tabular waveform of the mismatched signal, and the extracted RVALUE signals. The debugging agent uses the output of the waveform tracing tool to perform reasoning through a thought-action-observation process to generate new program code in the hardware description language, until program code without functional errors is generated.

At least one technical advantage of the disclosed techniques relative to the prior art is the disclosed techniques automatically generate program code in hardware description languages while implementing all of the details, such as state transition logic and other low-level circuit information, that are specified by natural language descriptions of hardware modules. In addition, the disclosed techniques automatically correct syntax and functional errors in the generated program code. Accordingly, more correct program code in hardware description languages can be generated relative to what could be generated using conventional approaches, allowing hardware to be developed faster and with fewer defects as well as improved functional correctness in the program code from which the hardware can be designed. These technical advantages represent one or more technological improvements over prior art approaches.

1. In some embodiments, a computer-implemented method for generating program code comprises receiving a natural language description of a hardware module, generating a first plan based on the natural language description, extracting first circuit information from the natural language description, generating a second plan based on the first plan and the first circuit information, and generating first program code in a hardware description language based on the second plan.

2. The computer-implemented method of clause 1, wherein the first plan comprises a plurality of sub-tasks, and wherein generating the second plan comprises generating a graph that comprises a plurality of first nodes representing the plurality of sub-tasks and one or more second nodes representing the first circuit information, retrieving, from the graph, second circuit information associated with each sub-task included in the plurality of sub-tasks, and generating the second plan based on the plurality of sub-tasks and the second circuit information.

3. The computer-implemented method of clauses 1 or 2, wherein retrieving the second circuit information comprises performing one or more breadth-first searches on the graph.

4. The computer-implemented method of any of clauses 1-3, wherein retrieving the second circuit information comprises performing one or more thought-action-observation tracing operations using an agent and a retrieval tool.

5. The computer-implemented method of any of clauses 1-4, wherein the first circuit information comprises at least one of a circuit signal, a state transition, or a signal example.

6. The computer-implemented method of any of clauses 1-5, wherein the first plan is generated using a first agent, the first circuit information is extracted using a second agent, the second plan is generated using a third agent, and the first program code is generated using a fourth agent.

7. The computer-implemented method of any of clauses 1-6, wherein generating the first plan comprises generating, using a first agent, a third plan based on the natural language description, generating, using a second agent, one or more suggestions for correcting one or more inconsistencies between the natural language description and the third plan, and generating, using the first agent, the first plan based on the one or more suggestions.

8. The computer-implemented method of any of clauses 1-7, wherein generating the first program code comprises generating, using a first agent, second program code in the hardware description language based on the second plan, generating, using a second agent, one or more suggestions for correcting one or more syntax errors in the second program code, and generating, using the first agent, the first program code based on the second program code and the one or more suggestions.

9. The computer-implemented method of any of clauses 1-8, wherein the second plan comprises a graph that includes one or more nodes representing one or more sub-tasks, and wherein generating the first program code comprises performing the one or more sub-tasks represented by the one or more nodes.

10. The computer-implemented method of any of clauses 1-9, further comprising correcting at least one syntax or functional error in the first program code to generate second program code in the hardware description language.

11. In some embodiments, one or more non-transitory computer-readable media store instructions that, when executed by at least one processor, cause the at least one processor to perform the steps of receiving a natural language description of a hardware module, generating a first plan based on the natural language description, extracting first circuit information from the natural language description, generating a second plan based on the first plan and the first circuit information, and generating first program code in a hardware description language based on the second plan.

12. The one or more non-transitory computer-readable media of clause 11, wherein the first plan comprises a plurality of sub-tasks, and wherein generating the second plan comprises generating a graph that comprises a plurality of first nodes representing the plurality of sub-tasks and one or more second nodes representing the first circuit information, retrieving, from the graph, second circuit information associated with each sub-task included in the plurality of sub-tasks, and generating the second plan based on the plurality of sub-tasks and the second circuit information.

13. The one or more non-transitory computer-readable media of clauses 11 or 12, wherein retrieving the second circuit information comprises performing one or more breadth-first searches on the graph.

14. The one or more non-transitory computer-readable media of any of clauses 11-13, wherein the first circuit information comprises at least one of a circuit signal, a state transition, or a signal example.

15. The one or more non-transitory computer-readable media of any of clauses 11-14, wherein the first plan is generated using a first agent, the first circuit information is extracted using a second agent, the second plan is generated using a third agent, and the first program code is generated using a fourth agent.

16. The one or more non-transitory computer-readable media of any of clauses 11-15, wherein each of the first agent, the second agent, the third agent, and the fourth agent comprises a least one trained machine learning model.

17. The one or more non-transitory computer-readable media of any of clauses 11-16, wherein generating the first plan comprises generating, using a first agent, a third plan based on the natural language description, generating, using a second agent, one or more suggestions for correcting one or more inconsistencies between the natural language description and the third plan, and generating, using the first agent, the first plan based on the one or more suggestions.

18. The one or more non-transitory computer-readable media of any of clauses 11-17, wherein generating the first program code comprises performing one or more thought-action-observation operations using at least one agent.

19. The one or more non-transitory computer-readable media of any of clauses 11-18, wherein the hardware description language is Verilog.

20. In some embodiments, a system comprises a memory storing instructions, and one or more processors, that when executing the instructions, are configured to perform the steps of receiving a natural language description of a hardware module, generating a first plan based on the natural language description, extracting first circuit information from the natural language description, generating a second plan based on the first plan and the first circuit information, and generating program code in a hardware description language based on the second plan.

1. In some embodiments, a computer-implemented method for debugging program code comprises receiving first program code in a hardware description language, simulating a hardware module based on the first program code to generate one or more simulation results that include one or more functional errors in the first program code, generating a tree data structure based on the one or more simulation results, tracing one or more waveforms based on the tree data structure and the one or more functional errors to determine one or more first signals, and generating second program code in the hardware description language based on the first program code and the one or more first signals.

2. The computer-implemented method of clause 1, further comprising identifying one or more syntax errors in the first program code, and correcting, using a trained machine learning model, the one or more syntax errors in the first program code.

3. The computer-implemented method of clauses 1 or 2, wherein the tree data structure comprises an abstract syntax tree (AST).

4. The computer-implemented method of any of clauses 1-3, wherein tracing the one or more waveforms comprises determining a first number of levels from a mismatched output signal included in the one or more simulation results, and invoking a waveform tracing tool based on the mismatched output signal and the first number of levels, wherein the waveform tracing tool outputs one or more second signals.

5. The computer-implemented method of any of clauses 1-4, wherein the waveform tracing tool outputs at least a tabular waveform of the mismatched output signal and the one or more second signals.

6. The computer-implemented method of any of clauses 1-5, wherein the waveform tracing tool outputs at least a hint to trace more levels from the mismatched output signal if the one or more second signals are insufficient to correct the mismatched output signal.

7. The computer-implemented method of any of clauses 1-6, wherein tracing the one or more waveforms further comprises, in response to determining the one or more second signals are insufficient to correct the mismatched output signal, invoking the waveform tracing tool based on the mismatched output signal and a second number of levels, and wherein the second number of levels is greater than the first number of levels.

8. The computer-implemented method of any of clauses 1-7, wherein the one or more first signals include one or more right-hand side value (RVALUE) signals.

9. The computer-implemented method of any of clauses 1-8, wherein receiving the first program code, generating the tree data structure, tracing the one or more waveforms, and generating the second program code are performed using an agent that comprises one or more trained machine learning models.

10. The computer-implemented method of any of clauses 1-9, wherein tracing the one or more waveforms comprises performing one or more thought-action-observation operations using an agent and a waveform tracing tool.

11. In some embodiments, one or more non-transitory computer-readable media store instructions that, when executed by at least one processor, cause the at least one processor to perform the steps of receiving first program code in a hardware description language, simulating a hardware module based on the first program code to generate one or more simulation results that include one or more functional errors in the first program code, generating a tree data structure based on the one or more simulation results, tracing one or more waveforms based on the tree data structure and the one or more functional errors to determine one or more first signals, and generating second program code in the hardware description language based on the first program code and the one or more first signals.

12. The one or more non-transitory computer-readable media of clause 11, wherein the instructions, when executed by the at least one processor, further cause the at least one processor to perform the steps of identifying one or more syntax errors in the first program code, and correcting, using a trained machine learning model, the one or more syntax errors in the first program code.

13. The one or more non-transitory computer-readable media of clauses 11 or 12, wherein the tree data structure comprises an abstract syntax tree (AST).

14. The one or more non-transitory computer-readable media of any of clauses 11-13, wherein tracing the one or more waveforms comprises determining a first number of levels from a mismatched output signal included in the one or more simulation results, and invoking a waveform tracing tool based on the mismatched output signal and the first number of levels, wherein the waveform tracing tool outputs one or more second signals.

15. The one or more non-transitory computer-readable media of any of clauses 11-14, wherein the waveform tracing tool outputs at least a hint to trace more levels from the mismatched output signal if the one or more second signals are insufficient to correct the mismatched output signal.

16. The one or more non-transitory computer-readable media of any of clauses 11-15, wherein tracing the one or more waveforms further comprises, in response to determining the one or more second signals are insufficient to correct the mismatched output signal, invoking the waveform tracing tool based on the mismatched output signal and a second number of levels, and wherein the second number of level is greater than the first number of levels.

17. The one or more non-transitory computer-readable media of any of clauses 11-16, wherein the one or more functional errors include one or more differences from functionality described in a natural language description of the hardware module.

18. The one or more non-transitory computer-readable media of any of clauses 11-17, wherein the first program code is generated using one or more agents.

19. The one or more non-transitory computer-readable media of any of clauses 11-18, wherein the hardware description language is Verilog.

20. In some embodiments, a system comprises a memory storing instructions, and one or more processors, that when executing the instructions, are configured to perform the steps of receiving first program code in a hardware description language, simulating a hardware module based on the first program code to generate one or more simulation results that include one or more functional errors in the first program code, generating a tree data structure based on the one or more simulation results, tracing one or more waveforms based on the tree data structure and the one or more functional errors to determine one or more first signals, and generating second program code in the hardware description language based on the first program code and the one or more first signals.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

We claim:

1. A computer-implemented method for debugging program code, the method comprising:
receiving first program code in a hardware description language;
simulating a hardware module based on the first program code to generate one or more simulation results that include one or more functional errors in the first program code;
generating a tree data structure based on the one or more simulation results;
tracing one or more waveforms based on the tree data structure and the one or more functional errors to determine one or more first signals; and
generating second program code in the hardware description language based on the first program code and the one or more first signals.

2. The computer-implemented method of claim 1, further comprising:
identifying one or more syntax errors in the first program code; and
correcting, using a trained machine learning model, the one or more syntax errors in the first program code.

3. The computer-implemented method of claim 1, wherein the tree data structure comprises an abstract syntax tree (AST).

4. The computer-implemented method of claim 1, wherein tracing the one or more waveforms comprises:
determining a first number of levels from a mismatched output signal included in the one or more simulation results; and
invoking a waveform tracing tool based on the mismatched output signal and the first number of levels, wherein the waveform tracing tool outputs one or more second signals.

5. The computer-implemented method of claim 4, wherein the waveform tracing tool outputs at least a tabular waveform of the mismatched output signal and the one or more second signals.

6. The computer-implemented method of claim 4, wherein the waveform tracing tool outputs at least a hint to trace more levels from the mismatched output signal if the one or more second signals are insufficient to correct the mismatched output signal.

7. The computer-implemented method of claim 4, wherein tracing the one or more waveforms further comprises, in response to determining the one or more second signals are insufficient to correct the mismatched output signal, invoking the waveform tracing tool based on the mismatched output signal and a second number of levels, and wherein the second number of levels is greater than the first number of levels.

8. The computer-implemented method of claim 1, wherein the one or more first signals include one or more right-hand side value (RVALUE) signals.

9. The computer-implemented method of claim 1, wherein receiving the first program code, generating the tree data structure, tracing the one or more waveforms, and generating the second program code are performed using an agent that comprises one or more trained machine learning models.

10. The computer-implemented method of claim 1, wherein tracing the one or more waveforms comprises performing one or more thought-action-observation operations using an agent and a waveform tracing tool.

11. One or more non-transitory computer-readable media storing instructions that, when executed by at least one processor, cause the at least one processor to perform the steps of:
receiving first program code in a hardware description language;
simulating a hardware module based on the first program code to generate one or more simulation results that include one or more functional errors in the first program code;
generating a tree data structure based on the one or more simulation results;
tracing one or more waveforms based on the tree data structure and the one or more functional errors to determine one or more first signals; and
generating second program code in the hardware description language based on the first program code and the one or more first signals.

12. The one or more non-transitory computer-readable media of claim 11, wherein the instructions, when executed by the at least one processor, further cause the at least one processor to perform the steps of:
identifying one or more syntax errors in the first program code; and
correcting, using a trained machine learning model, the one or more syntax errors in the first program code.

13. The one or more non-transitory computer-readable media of claim 11, wherein the tree data structure comprises an abstract syntax tree (AST).

14. The one or more non-transitory computer-readable media of claim 11, wherein tracing the one or more waveforms comprises:
determining a first number of levels from a mismatched output signal included in the one or more simulation results; and
invoking a waveform tracing tool based on the mismatched output signal and the first number of levels, wherein the waveform tracing tool outputs one or more second signals.

15. The one or more non-transitory computer-readable media of claim 14, wherein the waveform tracing tool outputs at least a hint to trace more levels from the mismatched output signal if the one or more second signals are insufficient to correct the mismatched output signal.

16. The one or more non-transitory computer-readable media of claim 14, wherein tracing the one or more waveforms further comprises, in response to determining the one or more second signals are insufficient to correct the mismatched output signal, invoking the waveform tracing tool based on the mismatched output signal and a second number of levels, and wherein the second number of level is greater than the first number of levels.

17. The one or more non-transitory computer-readable media of claim 11, wherein the one or more functional errors include one or more differences from functionality described in a natural language description of the hardware module.

18. The one or more non-transitory computer-readable media of claim 11, wherein the first program code is generated using one or more agents.

19. The one or more non-transitory computer-readable media of claim 11, wherein the hardware description language is Verilog.

20. A system, comprising:
a memory storing instructions; and
one or more processors, that when executing the instructions, are configured to perform the steps of:
receiving first program code in a hardware description language,
simulating a hardware module based on the first program code to generate one or more simulation results that include one or more functional errors in the first program code,
generating a tree data structure based on the one or more simulation results,
tracing one or more waveforms based on the tree data structure and the one or more functional errors to determine one or more first signals, and
generating second program code in the hardware description language based on the first program code and the one or more first signals.
